(19) United States
(12) Patent Application Publication
(10) Pub. No.: US 2013/0201583 A1
(43) Pub. Date: Aug. 8, 2013

(54) ELECTRONIC DEVICE AND METHOD FOR PROTECTING AGAINST DAMAGE BY ELECTROSTATIC DISCHARGE

(71) Applicant: Markus Rommel, Freising (DE)

(72) Inventor: Markus Rommel, Freising (DE)

(73) Assignee: TEXAS INSTRUMENTS DEUTSCHLAND GMBH, Freising (DE)

(21) Appl. No.: 13/366,432

(22) Filed: Feb. 6, 2012

(51) Int. Cl. H02H 9/00

(52) U.S. Cl. 361/56

(57) ABSTRACT

An electronic device with a protective circuit against damage by electrostatic discharge includes a discharge current path connectable between an input to be protected and a ground pin. An enabling circuit outputs a control signal for connecting the discharge current path in the event of an electrostatic discharge. A deactivating circuit which deactivates the enabling circuit during operation of the electronic device is controlled by the inverted control signal. A method of protecting an electronic device against damage by electrostatic discharge includes providing a control signal for connecting a discharge current path between an input to be protected and a ground pin in the event of an electrostatic discharge. An inverted control signal is applied to the inverted control signal to a deactivating circuit. The inverted control signal prevents connection of the discharge current path between the input to be protected and ground during operation of the electronic device.

### FIELD OF THE INVENTION

The invention relates to an electronic device comprising a protective circuit against damage by electrostatic discharge and to a method of protecting an electronic device against damage by electrostatic discharge.

### BACKGROUND OF THE INVENTION

Many electronic circuits may be severely damaged by electrostatic discharge (ESD). An electrostatic discharge on an input pin of an electronic component, especially a CMOS component, may lead to a current in the chip which is much higher than the currents for which the circuit is designed. The high current locally overheats the component and destroys parts of the chip structures.

A first prior art solution is shown in FIG. 1. A pin PAD is to be protected against an electrostatic discharge by a protective circuit. The protective circuit comprises a transistor MN1 the transistor channel of which is connected between the pin PAD and a pin VSS. Transistor MN1 is designed to support electrostatic discharge currents through its channel.

Pin PAD may be a pad to which a supply voltage is applied when the circuit which is protected by the protective circuit works normally. VSS may be a pin which is connected to ground.

A resistor R1 is connected between the gate of transistor MN1 and pin VSS. A transistor MN2 is connected with one side of the transistor channel to pin PAD and with the other side of the channel to the gate of transistor MN1. A transistor MN3 is connected with one side of the transistor channel to the gate of transistor MN1, and with the other side of the transistor channel to the pin VSS. Transistors MN2 and MN3 are connected in series between the pins PAD and VSS. An interconnection node between transistors MN2 and MN3 is connected to the gate of transistor MN1.

A series connection between a capacitor C1 and a resistor R2 is connected between pin PAD and pin VSS. One side of capacitor C1 is connected to pin PAD and the other side of capacitor C1 is connected to the gate of transistor MN2 and to one side of resistor R2. The other side of resistor R2 is connected to pin VSS.

A transistor MN4 is connected with one side of the transistor channel to the interconnection node between capacitor C1 and resistor R2 and with the other side to pin VSS. A pin V_OFF is connected to the gate of transistor MN3 and to the gate of transistor MN4.

When the component or chip comprising the prior art protective circuit according to FIG. 1 is handled before being mounted to a circuit board no supply voltages are applied to the pins PAD and V_OFF (V_OFF should be pulled to ground level).

In the event of an electrostatic discharge on pin PAD there is a sudden voltage rise on PAD. An electrostatic discharge pulse lasts generally only about 1 microsecond. The prior art protective circuit functions as a dV/dt-trigger or transient clamp. Through capacitor C1 a voltage VRC on the gate of transistor MN2 rises also very fast. The rise time of the voltage VRC can be controlled by the RC time constant τ1=C1*R2.

Voltage VRC on the gate of transistor MN2 causes it to conduct and the voltage at pin PAD leads to a voltage VG on the gate of transistor MN1. Transistor MN1 conducts and a discharge current can flow from pin PAD to pin VSS through the transistor channel of transistor MN1 without destroying the protected circuit.

Transistor MN2 functions as an auxiliary transistor to main transistor MN1 ensuring that enough current is provided to turn on transistor MN1 very fast. Once the protected circuit which is not shown in FIG. 1 is inserted including the protective circuit into an electronic device, for example mounted on a circuit board, and used normally, the protective circuit risks to disturb the normal function of the electronic device. During normal function of the protected circuit transistor MN1 must not conduct. Or in other words, it is not desired that a short circuit via transistor MN1 occurs, once the voltage supply connected between pin PAD and pin VSS.

In the first prior art solution as shown in FIG. 1 an additional pin V_OFF is provided to which during normal operation of the protected circuit an external control voltage V_OFF is applied. The voltage applied to pin V_OFF is applied directly to the gates of transistors MN3 and MN4 so that the channels of transistors MN3 and MN4 are conducting. With transistors MN3 and MN4 conducting, the gate voltage VRC of transistor MN2 and the gate voltage VG of transistor MN1 can not rise sufficiently anymore to switch transistors MN1 and MN2 and the protective circuit is disabled.

A disadvantage of the first prior art solution, which is widely used, is that an additional control voltage V_OFF is needed. Usually, the additional control voltage is provided by a further voltage supply. The top level routing of the entire integrated circuit comprising the protective circuit becomes more difficult as additional voltage lines are needed.

A further disadvantage is that the two supply voltages, the supply voltage between PAD and VSS and the supply voltage for V_OFF, may power up with different time constants. If the voltage V_OFF powers up later or slower than the voltage across PAD and VSS, a high current flows through MN1 during this delay time. This could damage the circuit or even the whole chip.

A second prior art solution is shown in FIG. 2. In the schematic diagram in FIG. 2 those components are provided with the same reference signs which are already included in the schematic diagram of the first prior art solution in FIG. 1. The circuit according to the second prior art solution is only explained insofar as it differs from the first prior art solution.

The circuit according to FIG. 2 also comprises transistors MN1, MN2, MN3 and MN4 which are interconnected and connected to a pin PAD and a pin VSS as the corresponding transistors in FIG. 1. Furthermore, a capacitor C1 and resistors R1 and R2 are also interconnected in the same way.

The second prior art solution avoids the use of a separate voltage V_OFF. Instead, a series connection of a resistor R3 and a capacitor C2 is connected between pin PAD and pin VSS. One side of capacitor C2 is connected to pin VSS and the other side of capacitor C2 is connected to the gates of transistors MN3 and MN4 and to one side of resistor R3. The other side of resistor R3 is connected to pin PAD.

Resistor R3 and capacitor C2 form together a low pass filter with an RC time constant τ2=R3*C2. In the event of an electrostatic discharge the time constant τ2 and the low pass filter characteristic in general prevent building up of a gate voltage on the gates of transistors MN3 and MN4. Transistors MN3 and MN4 remain non-conducting and a gate voltage VRC switches transistor MN2. With the transistor channel of transistor MN2 conducting a gate voltage on the gate of transistor MN1 switches transistor MN1 and the electrostatic discharge current flows through the transistor channel of transistor MN1 between PAD and VSS as in the first prior art solution.

Once the protected circuit is inserted to an electronic device, for example mounted on a circuit board, and used normally, the low pass filter formed by resistor R3 and capacitor C2 will lead during the much slower power up process to a gate voltage on transistors MN3 and MN4 so that the transistors MN3 and MN4 are conducting and no gate voltages build up on the gates of transistors MN1 and MN2. Once the voltage on PAD is the constant supply voltage of the electronic device or the electronic circuit to be protected, the gate voltage on transistors MN3 and MN4 will remain constant and transistors MN3 and MN4 are conducting.

The time constant τ2 must be greater than the time constant τ1 which triggers the circuit in case of an electrostatic discharge pulse. If the time constant τ2 is too low, a gate voltage will build up on the gates of transistors MN3 and MN4 which is sufficient to switch these transistors before a gate voltage on gates of transistors MN1 and MN2 is sufficient to make the channels of these two transistors conductive. In this case the protective circuit does not work in the event of an electrostatic discharge and the circuit to be protected could be damaged. If the time constants τ1 and τ2 are chosen too close together, it is possible that the ESD protection is switched off too early. Therefore, the selection of the time constants is critical and may lead to failure of the circuit.

A further disadvantage of the second prior art solution is the additional silicon area needed for resistor R3 and capacitor C2. Capacitors and resistors are space-consuming components which are much larger than transistors. In an embodiment, the silicon area required may be around 2,600 μm².

### SUMMARY OF THE INVENTION

It is a general object of the invention to provide a protective circuit protecting against damage by electrostatic discharge which may be deactivated during normal operation of the protected circuit without the need to provide an additional voltage supply and requiring less silicon area.

In one aspect of the invention an electronic device (for example an integrated semiconductor circuit) is provided comprising a protective circuit against damage by electrostatic discharge. The protective circuit may include a discharge current path which is configured to be coupled between an input to be protected and a ground pin. There may be an enabling circuit configured to output a control signal for enabling the discharge current path in the event of an electrostatic discharge. A deactivating circuit can be configured to deactivate the enabling circuit during operation of the electronic device. The deactivating circuit may be controlled by the inverted control signal.

The control signal which is used to connect the discharge current path or in other words to enable the discharge current path in the event of an electrostatic discharge is used in inverted form for deactivating the protective circuit during normal operation of the electronic device.

In an embodiment of the invention, the discharge current path may comprise a first transistor. The control signal may be applied to the control gate of the first transistor. It is known in the art to design a transistor to support a maximal current.

In a further embodiment, the enabling circuit may comprise a high pass filter which is coupled between the input to be protected and ground. The control signal may then depend on the output signal of the high pass filter.

A high pass filter may be designed to have a time constant adapted to the time response of an ESD event. Using a high pass filter provides a dV/dt-trigger responding to fast voltage rises as they occur during ESD events. As the control signal depends on the output signal of the high pass filter, only voltage signals having a short rise time will result in a control signal. The much slower power up provides a voltage rise which does not cause a control signal.

In an embodiment, the high pass filter may comprise a series connection of a resistor and a capacitor. Such a high pass filter only needs very few components.

In an embodiment, the deactivating circuit comprises a second transistor and an inverter. The inverter may be coupled to receive the control signal at an inverter input. The inverter is further coupled to output the inverted control signal to a control gate of the second transistor. The inverter is adapted to provide the inverted control signal needed to control the deactivating circuit.

In a further embodiment, the inverter comprises a third and a fourth transistor. The channels of the third and fourth transistors may be connected in series between the input to be protected and the ground pin. The gates of the third and the fourth transistor may then form the inverter input. This means that only two transistors are needed to provide the inverted control signal. The inverted control signal may be used to deactivate the enabling circuit. The silicon area needed for a transistor is much smaller than the silicon area required for a capacitor or for a resistor.

In an embodiment, the channel of the second transistor may be coupled between an output of the enabling circuit and the ground pin. A control signal output from the enabling circuit may then be led directly to ground via the channel of the second transistor. In this case the control signal cannot activate the discharge current path.

In a further aspect of the invention, a method of protecting an electronic device against damage by electrostatic discharge is provided. The method may comprise the following steps: providing a control signal for connecting a discharge current path between an input to be protected and a ground pin in the event of an electrostatic discharge. This means that the discharge current path is only connected between input and ground pin in an ESD event. Whether the discharge current path is connected or not is controlled by the control signal.

A further step is providing an inverted control signal. The inverted control signal may be applied to a deactivating circuit. The inverted control signal may be configured to prevent connection of the discharge current path between the input to be protected and the ground pin during operation of the electronic device.

### BRIEF DESCRIPTION OF DRAWINGS

Further aspects of the invention will appear from the appending claims and from the following detailed description given with reference to the appending drawings.

FIG. 1 shows a schematic circuit diagram of a protective circuit according to a first solution in the prior art;

FIG. 2 shows a schematic circuit diagram according to a second prior art solution; and

FIG. 3 shows a representative schematic of an electronic device according to the invention.

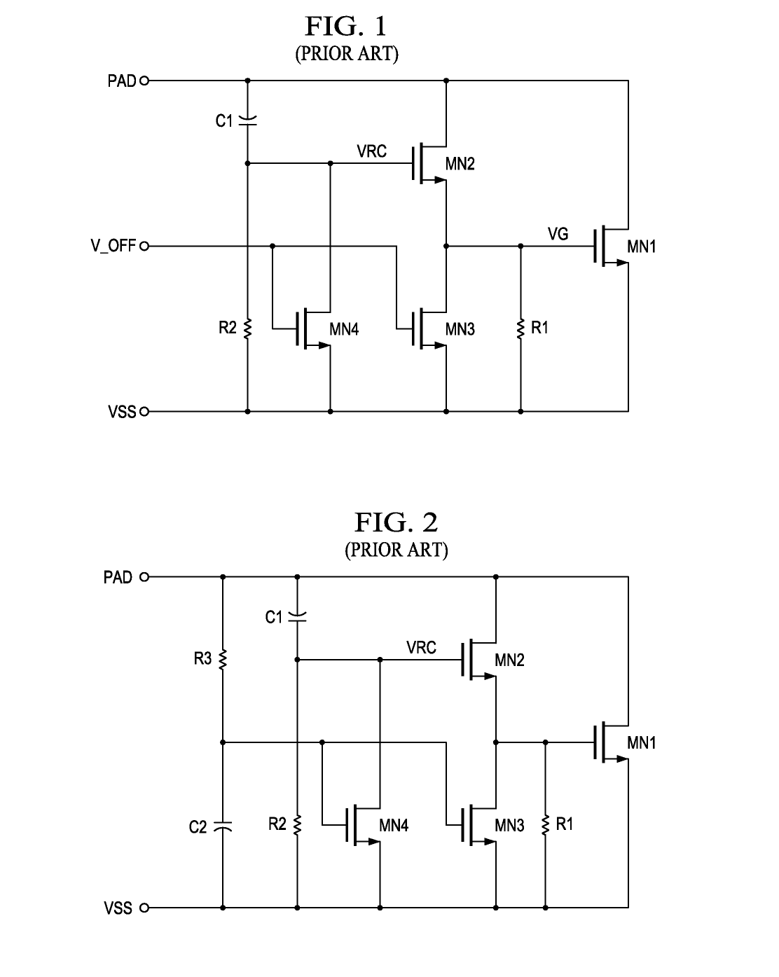

### DETAILED DESCRIPTION OF EXAMPLE EMBODIMENTS

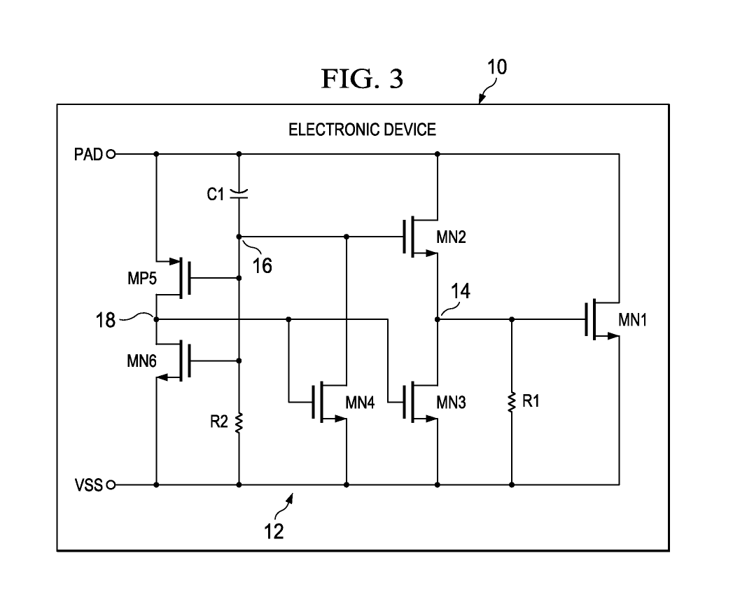

FIG. 3 shows a representative schematic of an electronic device according to the invention. In the embodiment shown an electronic device 10 comprises a protective circuit 12.

In the embodiment shown components which are already used in the prior art solutions have the same reference signs.

The protective circuit 12 comprises a transistor MN1 which may be an NMOS transistor. Transistor MN1 is connected with its channel between an input pin PAD which is to be protected against an ESD event and a ground pin designated by VSS. Transistor MN1 provides as first transistor a discharge current path according to the invention. The channel or discharge current path is conducting respectively enabled or not conducting respectively disabled between the input PAD and the ground pin in accordance with a voltage applied to the gate of transistor MN1. The gate of transistor MN1 is connected via a resistor R1 to pin VSS.

A series connection of the channels of a transistor MN2 and transistor MN3 is connected between the input PAD and the pin VSS. Transistors MN2 and MN3 may be NMOS transistors. An interconnection node 14 between transistors MN2 and MN3 is connected to the gate of transistor MN1. Transistor MN3 can be a second transistor in the wording of the claims.

A series connection between a capacitor C1 and a resistor R2 is connected between pin PAD and pin VSS. Capacitor C1 is connected with one side to pin PAD and with the other side to resistor R2. Resistor R2 is connected with the other side to pin VSS. An interconnection node 16 between capacitor C1 and resistor R2 is connected to the gate of transistor MN2.

A transistor MN4 which may be an NMOS transistor is connected with its channel between the interconnection node 16 and pin VSS.

A series connection between a transistor MP5 which may be a PMOS transistor and a transistor MN6 which may be an NMOS transistor is connected between pin PAD and pin VSS. The source of transistor MP5 is connected to pin PAD and the drain of transistor MP5 is connected to the drain of transistor MN6. Transistor MN6 is connected with its source to pin VSS. An interconnection node 18 between transistor MP5 and transistor MN6 is connected to the gate of transistor MN4 and to the gate of transistor MN3. The gate of transistor MP5 and the gate of transistor MN6 are connected to interconnection node 16 between capacitor C1 and resistor R2. Transistors MP5 and MN6 form, as a third and fourth transistor together, an inverter. The gates of transistors MP5 and MN6 form an input of the inverter and interconnection node 18 forms an output of the inverter.

In operation, a discharge current path is provided by the channel of transistor MN1 between pin PAD to be protected against an electrostatic discharge and pin VSS when the voltage applied to the gate of transistor MN1 is such that the transistor channel is conductive. In other words, the gate voltage of transistor MN1 enables or disables the discharge current path.

An enabling circuit is formed by a high pass filter formed by capacitor C1 and resistor R2. At their interconnection node 16 an enabling signal or control signal for connecting the discharge current path is provided.

A deactivating circuit is formed by second transistor MN3 and the inverter comprising transistors MP5 and MN6. In the embodiment shown, the deactivating circuit further comprises transistor MN4. If transistor MN3 is conductive, the gate voltage of MN1 drops to VSS. If MN4 is conductive, the gate voltage of transistor MN2 drops to VSS. In other words MN3 and MN4 can deactivate transistors MN1 and MN2.

Transistors MN3 and MN4 become conductive by applying an adequate gate signal. The gate signal is provided on interconnection node 18 between transistors MP5 and MN6, in other words at the output of the inverter formed by transistors MP5 and MN6. The signal on interconnection node 18 is the inverted control signal of interconnection node 16.

The inverted control signal is applied to the gates of transistors MN3 and MN4. When transistors MN3 and MN4 are conducting they deactivate enabling of the discharge current path.

In the event of an electrostatic discharge, the voltage on pin PAD rises very fast. Capacitor C1 is in the beginning not charged so that the voltage on the gate of transistor MN2 rises also very fast and the channel of transistor MN2 turns on quickly. A current flows from pin PAD through the channel of transistor MN2 and via interconnection node 14 through resistor R1 to VSS. This means that the gate voltage of transistor MN1 rises very fast and the discharge current path through transistor MN1 is enabled.

It is to be understood that transistor MN2 is an auxiliary transistor which is not essential for the invention and transistor MN4 is only needed to deactivate the auxiliary transistor MN2. The use of MN2 allows reducing the capacitance of capacitor C1 while still providing sufficiently high current in order to switch transistor MN1 quickly. The discharge current can pass securely transistor MN1 without damaging the electronic device.

Once the protective circuit is mounted on a circuit board or integrated into an electronic device and a normal power up of a supply voltage on pin PAD occurs, the voltage rises much slower than in an ESD event. Due to the high pass filter characteristic of C1 and R2, the power rises only slowly at interconnection node 16. Interconnection node 16 is connected to the gates of transistors MP5 and MN6 which form an inverter input. While the voltage at interconnection node 16 is low transistor MP5 is conductive and transistor MN6 is non-conductive. As transistor MP5 is conductive, the voltage at interconnection node 18 becomes essentially the same voltage than the voltage on pin PAD. Interconnection node 18 forms the inverter output. The signal at interconnection node 18 is the inverted signal of the signal at interconnection node 16, i.e. when the voltage at interconnection node 16 is low, the voltage at interconnection node 18 is high.

The voltage at interconnection node 18 is applied to the gates of transistors MN3 and MN4. Transistors MN3 and MN4 become conductive and the voltage at interconnection node 16 between capacitor C1 and resistor R2 drops. This means that the enabling circuit formed by capacitor C1 and resistor R2 is deactivated because there may be no control signal enabling the discharge current path.

This means when there is a slow voltage rise on PAD or a constant voltage on PAD transistors MN3 and MN4 are conductive and transistors MN1 and MN2 cannot become conductive.

The voltage at interconnection node 16 respectively on the gate of transistor MN2 falls with the R2*C1 time constant.

During normal operation of the electronic device, the voltage on pin PAD is generally constant and capacitor C1 blocks current flow. Transistors MN3 and MN4 remain conductive and the electrostatic discharge current path remains disabled.

It is important to realize that no additional RC time constant is needed with the inventive circuit and no further voltage supply is required.

For the realization of an inverter comprising a PMOS transistor MP5 and an NMOS transistor MN6 as described with reference to the embodiment shown in FIG. 3, only a silicon space or a silicon area of 440 μm² is needed to support the self-deactivation. Compared to the 2,300 μm² needed for an additional RC circuit this means an area reduction of over 80% in this embodiment.

Although the invention has been described in detail, it should be understood that various changes, substitutions and alterations can be made thereto without departing from the spirit and scope of the invention as defined by the appended claims.

1. An electronic device comprising:
a protective circuit against damage by electrostatic discharge, the protective circuit including:
a discharge current path configured to be connectable between an input to be protected and a ground pin;
an enabling circuit configured to output a control signal for enabling the discharge current path in the event of an electrostatic discharge;
a deactivating circuit configured to deactivate the enabling circuit during operation of the electronic device;
wherein the deactivating circuit is controlled by an inverted control signal.

2. The electronic device according to claim 1, wherein the discharge current path comprises a first transistor and wherein the control signal acts upon the control gate of the first transistor.

3. The electronic device according to claim 1, wherein the enabling circuit comprises a high-pass filter coupled between the input to be protected and ground and wherein the control signal is the output signal of the high-pass filter.

4. The electronic device according to claim 2, wherein the enabling circuit comprises a high-pass filter coupled between the input to be protected and ground and wherein the control signal is the output signal of the high-pass filter.

5. The electronic device according to claim 3, wherein the high-pass filter comprises a series connection of a resistor and a capacitor and wherein an interconnection node between the resistor and the capacitor is coupled to the control gate of the first transistor.

6. The electronic device according to claim 4, wherein the high-pass filter comprises a series connection of a resistor and a capacitor and wherein an interconnection node between the resistor and the capacitor is coupled to the control gate of the first transistor.

7. The electronic device according to claim 1, wherein the deactivating circuit comprises a second transistor and an inverter, the inverter being coupled to receive the control signal at an inverter input and to output the inverted control signal to a control gate of the second transistor.

8. The electronic device according to claim 2, wherein the deactivating circuit comprises a second transistor and an inverter, the inverter being coupled to receive the control signal at an inverter input and to output the inverted control signal to a control gate of the second transistor.

9. The electronic device according to claim 3, wherein the deactivating circuit comprises a second transistor and an inverter, the inverter being coupled to receive the control signal at an inverter input and to output the inverted control signal to a control gate of the second transistor.

10. The electronic device according to claim 4, wherein the deactivating circuit comprises a second transistor and an inverter, the inverter being coupled to receive the control signal at an inverter input and to output the inverted control signal to a control gate of the second transistor.

11. The electronic device according to claim 5, wherein the deactivating circuit comprises a second transistor and an inverter, the inverter being coupled to receive the control signal at an inverter input and to output the inverted control signal to a control gate of the second transistor.

12. The electronic device according to claim 6, wherein the deactivating circuit comprises a second transistor and an inverter, the inverter being coupled to receive the control signal at an inverter input and to output the inverted control signal to a control gate of the second transistor.

13. The electronic device according to claim 7, wherein the inverter comprises a third and a fourth transistor, the channel of the third transistor and the channel of the fourth transistor being connected in series between the input to be protected and the ground pin and the gates of the third and the fourth transistor forming the inverter input.

14. The electronic device according to claim 8, wherein the inverter comprises a third and a fourth transistor, the channel of the third transistor and the channel of the fourth transistor being connected in series between the input to be protected and the ground pin and the gates of the third and the fourth transistor forming the inverter input.

15. The electronic device according to claim 9, wherein the inverter comprises a third and a fourth transistor, the channel of the third transistor and the channel of the fourth transistor being connected in series between the input to be protected and the ground pin and the gates of the third and the fourth transistor forming the inverter input.

16. The electronic device according to claim 10, wherein the inverter comprises a third and a fourth transistor, the channel of the third transistor and the channel of the fourth transistor being connected in series between the input to be protected and the ground pin and the gates of the third and the fourth transistor forming the inverter input.

17. The electronic device according to claim 11, wherein the inverter comprises a third and a fourth transistor, the channel of the third transistor and the channel of the fourth transistor being connected in series between the input to be protected and the ground pin and the gates of the third and the fourth transistor forming the inverter input.

18. The electronic device according to claim 12, wherein the inverter comprises a third and a fourth transistor, the channel of the third transistor and the channel of the fourth transistor being connected in series between the input to be protected and the ground pin and the gates of the third and the fourth transistor forming the inverter input.

19. The electronic device according to claim 7, wherein a channel of the second transistor is coupled between an output of the enabling circuit and the ground pin.

20. A method of protecting an electronic device against damage by electrostatic discharge, the method comprising:
providing a control signal for connecting a discharge current path between an input to be protected and a ground pin in the event of an electrostatic discharge;
providing an inverted control signal;
applying the inverted control signal to a deactivating circuit;
wherein the inverted control signal is configured to prevent connection of the discharge current path between the input to be protected and ground during operation of the electronic device.
